(19) United States
(12) Patent Application Publication
(10) Pub. No.: US 2013/0191071 A1
(43) Pub. Date: Jul. 25, 2013

(54) SYSTEM AND METHOD FOR AUTOMATIC MODAL PARAMETER EXTRACTION IN STRUCTURAL DYNAMICS ANALYSIS

(71) Applicant: AIRBUS ENGINEERING CENTRE INDIA, Bangalore (IN)

(72) Inventor: KAUSTAV MITRA, Bangalore (IN)

(73) Assignee: AIRBUS ENGINEERING CENTRE INDIA, Bangalore (IN)

(21) Appl. No.: 13/743,333

(22) Filed: Jan. 17, 2013

(30) Foreign Application Priority Data
Jan. 23, 2012 (IN) 283/CHE/2012

(51) Int. Cl. G06F 17/18

(52) U.S. Cl. CPC G06F 17/18
USPC 702/180

(57) ABSTRACT

A system and method for automatic modal parameter extraction in structural dynamics analysis are disclosed. In one embodiment, a stabilization diagram of a structure is obtained using a frequency domain parameter extraction technique. The stabilization diagram is a graph of measured transfer functions which include stable poles of the structure for each modal order versus frequencies which include modal frequencies of each stable pole. Further, a user is allowed to input user modal parameters, such as a maximum damping ratio, maximum number of stable poles to be selected from the stabilization diagram, and minimum separation in frequency between consecutive stable poles. Furthermore, stable poles having a damping ratio less than or equal to the maximum damping ratio are obtained. A histogram having bins, with a width equal to the minimum separation in frequency, is obtained. Also, the modal parameter of the structure is automatically extracted using the histogram.

### RELATED APPLICATION

Benefit is claimed under 35 U.S.C. 119(a)-(d) to Foreign Application Serial No. 283/CHE/2012, filed in INDIA entitled “SYSTEM AND METHOD FOR AUTOMATIC MODAL PARAMETER EXTRACTION IN STRUCTURAL DYNAMICS ANALYSIS” by Airbus Engineering Centre India, filed on Jan. 23, 2012, which is herein incorporated in its entirety by reference for all purposes.

### FIELD OF TECHNOLOGY

Embodiments of the present subject matter relate to structural dynamics. More particularly, the embodiments of the present subject matter relate to automatic modal parameter extraction of a structure.

### BACKGROUND

In the field of structural dynamics analysis, it is often essential to determine structural resonances or modal parameters of a given structure. While a typical test structure, in theory, may have an infinite number of discrete resonances, within a frequency range of interest, typically, only a finite number of resonances need to be identified.

Generally, modal parameters are estimated by applying excitation signals at various locations on the test structure while obtaining response signals of measurement parameters, such as displacement, force, and/or acceleration at a number of measurement locations, some of which may correspond to the excitation locations. The obtained response signals are then analyzed to extract the desired set of modal parameters.

Current techniques to extract the modal parameters include using a frequency based modal parameter extraction algorithm to construct a stabilization diagram which can give an indication of presence of poles in the test structure. However, these techniques, even with experienced analysts, may pose new challenges, such as, uncertainty in the accuracy of the obtained results, inconsistency between estimates of the modal parameters obtained by different analysts, tedious task of selecting obvious poles in the stabilization diagram and the time-consuming iterations required to validate modal parameters.

### SUMMARY

A system and method for automatic modal parameter extraction in structural dynamics analysis are disclosed. According to one aspect of the present subject matter, a stabilization diagram of the structure is obtained using a frequency domain modal parameter extraction technique. In one embodiment, the stabilization diagram is a graph of measured transfer functions versus frequencies. The measured transfer functions include stable poles of the structure for each modal order and the frequencies include modal frequencies of each of the stable poles. Further, a user is allowed to input user modal parameters, such as a maximum damping ratio, a maximum number of stable poles to be selected from the stabilization diagram and a minimum separation in frequency between consecutive stable poles.

Furthermore, stable poles having a damping ratio that is less than or equal to the maximum damping ratio are obtained. In addition, a histogram having bins is formed. In one embodiment, each bin has a width approximately equal to the minimum separation in frequency between consecutive stable poles. Moreover, the modal parameter of the structure is automatically extracted using the histogram.

According to another aspect of the present subject matter, at least one non-transitory computer-readable storage medium for the automatic modal parameter extraction in structural dynamics analysis, having instructions that, when executed by a computing device causes the computing device to perform the method described above.

According to yet another aspect of the present subject matter, an automatic modal parameter extraction system includes a processor and memory coupled to the processor. Further, the memory includes a modal parameter extraction tool. In one embodiment, the modal parameter extraction tool includes instructions to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a flow diagram of an exemplary method for automatic modal parameter extraction in structural dynamics analysis of a structure, according to one embodiment;

FIG. 2 illustrates a stabilization diagram for a brake disc structure, according to one embodiment;

FIG. 3 illustrates automatically selected stable poles from the stabilization diagram, such as the one shown in FIG. 2, according to one embodiment; and

FIG. 4 illustrates a modal parameter extraction system including a modal parameter extraction tool for automatic extraction of the modal parameter in the structural dynamics analysis of the structure, using the process described with reference to FIG. 1, according to one embodiment.

The drawings described herein are for illustration purposes only and are not intended to limit the scope of the present disclosure in any way.

### DETAILED DESCRIPTION

A system and method for automatic modal parameter extraction in structural dynamics analysis are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

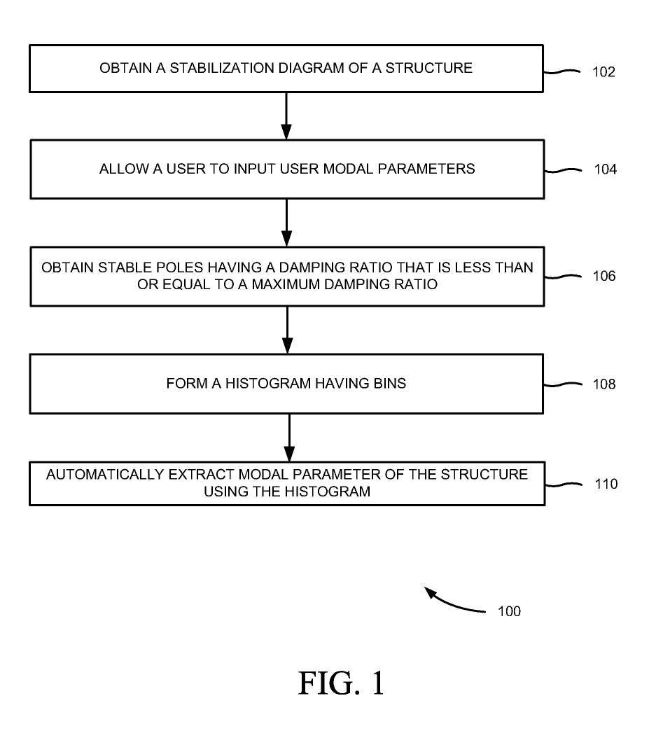

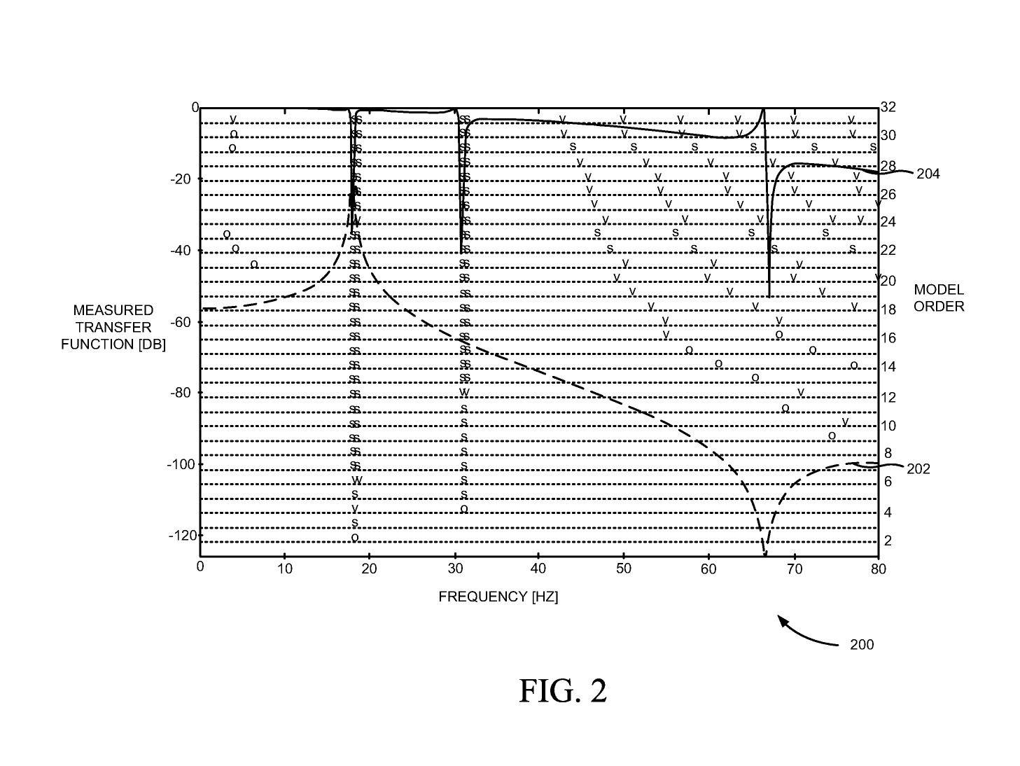

FIG. 1 illustrates a flow diagram 100 of an exemplary method for automatic modal parameter extraction in structural dynamics analysis of a structure, according to one embodiment. Exemplary structure includes an aircraft structure, an automobile structure, a brake disc structure and the like. Exemplary modal parameter of the structure includes a natural frequency, a mode shape, a damping ratio and the like. At block 102, a stabilization diagram of the structure is obtained from a frequency domain modal parameter extraction technique. In this embodiment, the stabilization diagram is a graph of measured transfer functions versus frequencies. The measured transfer functions include stable poles of the structure for each modal order and the frequencies include modal frequencies of each of the stable poles. This is explained in more detail with reference to FIG. 2. At block 104, a user is allowed to input user modal parameters, such as a maximum damping ratio, a maximum number of stable poles to be selected from the stabilization diagram and a minimum separation in frequency between consecutive stable poles.

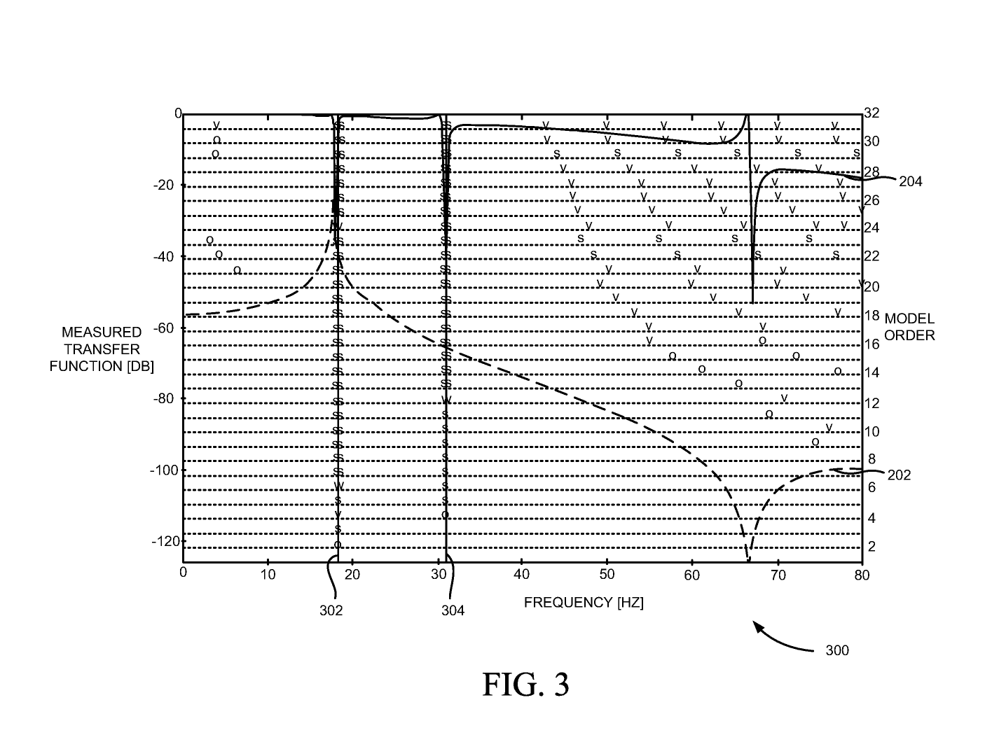

At block 106, stable poles having a damping ratio that is less than or equal to the maximum damping ratio are obtained. At block 108, a histogram having bins is formed. In this embodiment, each bin has a width approximately equal to the minimum separation in frequency between consecutive stable poles. At block 110, the modal parameter of the structure is automatically extracted using the histogram. In one embodiment, the modal parameter of the structure is automatically extracted by filtering out bins having no stable poles. Further, remaining bins are selected in a decreasing order of a number of stable poles in each of the remaining bins. Furthermore, a distance parameter is calculated for each of the stable poles in one of the remaining bins. In addition, a first difference is calculated for each of the stable poles in the one of the remaining bins in an increasing order of frequency. Also, one of the stable poles having a minimum first difference is selected in the one of the remaining bins. Further, the steps of calculating the distance parameter, calculating the first difference and selecting a stable pole are repeated for a next bin of the remaining bins. This is explained in more detail with reference to FIG. 3.

Referring now to FIG. 2, which illustrates a stabilization diagram 200 for a brake disc structure, according to one embodiment. In this embodiment, the stabilization diagram 200 is obtained by analyzing the brake disc structure for model orders up to 32. The stabilization diagram 200 is a graph of measured transfer functions versus frequencies. The measured transfer functions include stable poles of the brake disc structure for each modal order obtained from a frequency domain modal parameter extraction method and the frequencies include modal frequencies of each of the stable poles. In the stabilization diagram 200, ‘s’ indicates a stable pole of the brake disc structure, ‘o’ indicates a zero of the brake disc structure and ‘v’ indicates poles which have converged in the modal frequencies and modal participation between successive model orders but not converged in a damping ratio. Further in the stabilization diagram 200, x-axis indicates the frequencies, right y-axis indicates a modal order and left y-axis indicates the measured transfer functions. Furthermore in the stabilization diagram 200, 202 indicates an algebraic sum of all frequency response functions measured at all finite points of the brake disc structure and 204 indicates a complex mode indicator function. In this embodiment, the brake disc structure is excited by a single input source for measuring the frequency response functions at defined locations.

In operation, the stabilization diagram 200 is obtained from the frequency domain modal parameter extraction method. In one embodiment, in the frequency domain modal parameter extraction method, a set of measured transfer functions of the brake disc structure is analyzed. For example, a measured transfer function is a rational expression with polynomial expressions in numerator and denominator. The measured transfer function is typically expressed using the equation:

$$H ( z ) = \frac{{b}_{0} + {b}_{1} z + {b}_{2} {z}^{1} + … + {b}_{n} {z}^{n}}{{a}_{0} + {a}_{1} z + {a}_{2} {z}^{1} + … + {a}_{m} {z}^{m}}$$

where a₀ to aₘ and b₀ to bₙ, are transfer function modal parameters and z is a z-transform and can be expressed using the equation:

z=exp[(−ξ+jω)Tₛ)

where Tₛ is a sampling frequency of measured data, ξ is a modal damping ratio, m is the modal order and w is an angular frequency, which can be expressed using the equation:

ω=2πf

where f is a modal frequency (Hz).

Referring now to FIG. 3, which illustrates automatically selected stable poles 302 and 304 from the stabilization diagram 200. In operation, the user is allowed to input user modal parameters, such as the maximum damping ratio, the maximum number of stable poles to be selected from the stabilization diagram, and the minimum separation in frequency between consecutive stable poles are obtained. Further, a list of all stable poles is obtained from the stabilization diagram 200. In this embodiment, the list of all stable poles includes a frequency, a damping ratio and modal participation of each stable pole for a given modal order. Furthermore, stable poles having a damping ratio that is less than or equal to the maximum damping ratio are obtained from the obtained list of all stable poles. In addition, a histogram having bins with a width approximately equal to the minimum separation in frequency between the consecutive stable poles is formed. In addition, in the histogram, bins having no stable poles are filtered out. Also, remaining bins are selected in a decreasing order of a number of stable poles in each of the remaining bins.

Further in operation, a distance parameter (A) for each of the stable poles in one of the remaining bins is calculated. The distance parameter is a distance of the stable pole in the hypothetical (f-ξ) plane. In the hypothetical plane, the x-axis is frequency in Hertz (Hz) and the y-axis is a damping ratio. The frequency and damping ratio is estimated for each of the stable poles in one of the remaining bins. Furthermore, a first difference (Δλ) is calculated for each of the stable poles in the one of the remaining bins in an increasing order of frequency. In one embodiment, the first difference is a difference between the distance parameter of a current stable pole and the distance parameter of a previous stable pole in the one of the remaining bins. In addition, one of the stable poles having a minimum Δλ is selected in the one of the remaining bins. The minimum Δλ indicates an estimate of local minima in the hypothetical plane for the one of the remaining bins and highest probability of the local minima in the stable poles that is formed in the one of the remaining bins. Also, the steps of calculating the distance parameter, calculating the first difference and selecting the stable poles are repeated for a next bin of the remaining bins.

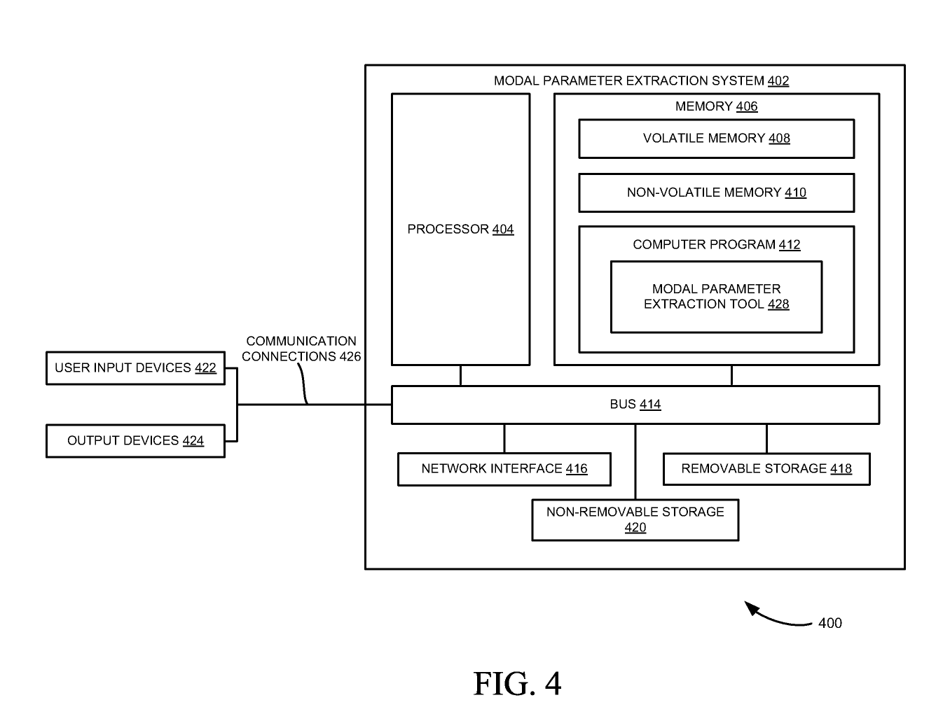

Referring now to FIG. 4, which illustrates a modal parameter extraction system 402 including a modal parameter extraction tool 428 for automatic modal parameter extraction in the structural dynamics analysis of the structure, using the process described with reference to FIG. 1, according to one embodiment. FIG. 4 and the following discussions are intended to provide a brief, general description of a suitable computing environment in which certain embodiments of the inventive concepts contained herein are implemented.

The modal parameter extraction system 402 includes a processor 404, memory 406, a removable storage 418, and a non-removable storage 420. The modal parameter extraction system 402 additionally includes a bus 414 and a network interface 416. As shown in FIG. 4, the modal parameter extraction system 402 includes access to the computing system environment 400 that includes one or more user input devices 422, one or more output devices 424, and one or more communication connections 426 such as a network interface card and/or a universal serial bus connection.

Exemplary user input devices 422 include a digitizer screen, a stylus, a trackball, a keyboard, a keypad, a mouse and the like. Exemplary output devices 424 include a display unit of the personal computer, a mobile device, the FMS, and the like. Exemplary communication connections 426 include a local area network, a wide area network, and/or other network.

The memory 406 further includes volatile memory 408 and non-volatile memory 410. A variety of computer-readable storage media are stored in and accessed from the memory elements of the modal parameter extraction system 402, such as the volatile memory 408 and the non-volatile memory 410, the removable storage 418 and the non-removable storage 420. The memory elements include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 404, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 404 also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 404 of the modal parameter extraction system 402. For example, a computer program 412 includes machine-readable instructions capable of performing automatic modal parameter extraction in the modal parameter extraction system 402, according to the teachings and herein described embodiments of the present subject matter. In one embodiment, the computer program 412 is included on a compact disk-read only memory (CD-ROM) and loaded from the CD-ROM to a hard drive in the non-volatile memory 410. The machine-readable instructions cause the modal parameter extraction system 402 to encode according to the various embodiments of the present subject matter.

As shown, the computer program 412 includes the modal parameter extraction tool 428. For example, the modal parameter extraction tool 428 can be in the form of instructions stored on a non-transitory computer-readable storage medium. The non-transitory computer-readable storage medium having the instructions that, when executed by the modal parameter extraction system 402, causes the modal parameter extraction system 402 to perform the one or more methods described in FIGS. 1 through 3.

In various embodiments, the system and method described in FIGS. 1 through 4 enable automatic selection of stable poles from the stabilization diagram of the structure. The above technique enables a significantly faster selection of stable poles in a structure in structural dynamics analysis.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method of automatic modal parameter extraction in structural dynamics analysis, comprising:
obtaining a stabilization diagram of a structure using a frequency domain modal parameter extraction technique, wherein the stabilization diagram is a graph of measured transfer functions versus frequencies and wherein the measured transfer functions comprise stable poles of the structure for each modal order and the frequencies comprise modal frequencies of each of the stable poles;
allowing a user to input user modal parameters selected from the group consisting of a maximum damping ratio, a maximum number of stable poles to be selected from the stabilization diagram, and a minimum separation in frequency between consecutive stable poles;
obtaining stable poles having a damping ratio that is less than or equal to the maximum damping ratio from the stabilization diagram;
forming a histogram having bins, wherein each bin having a width approximately equal to the minimum separation in frequency between the consecutive stable poles; and
automatically extracting the modal parameter of the structure using the histogram.

2. The method of claim 1, wherein the structure is an aircraft structure, an automobile structure, a bridge structure, a building structure, an engine structure, and/or a brake disc structure.

3. The method of claim 1, wherein the modal parameter of the structure is selected from the group consisting of a natural frequency, a mode shape and a damping ratio.

4. The method of claim 1, wherein automatically extracting the modal parameter of the structure using the histogram comprises:
filtering out bins having no stable poles;
selecting remaining bins in a decreasing order of a number of stable poles in each of the remaining bins; and
extracting the modal parameter of the structure using the selected remaining bins.

5. The method of claim 4, wherein extracting the modal parameter of the structure using the selected remaining bins comprises:
calculating a distance parameter for each of the stable poles in one of the remaining bins;
calculating a first difference for each of the stable poles in the one of the remaining bins in an increasing order of frequency; and
selecting one of the stable poles having a minimum first difference in the one of the remaining bins.

6. The method of claim 5, further comprising:
repeating the steps of calculating the distance parameter, calculating the first difference and selecting a stable pole in a next bin of the remaining bins.

7. A modal parameter extraction system, comprising:
a processor; and
memory coupled to the processor, wherein the memory includes a modal parameter extraction tool having instructions to:
obtain a stabilization diagram of a structure using a frequency domain modal parameter extraction technique, wherein the stabilization diagram is a graph of measured transfer functions versus frequencies and wherein the measured transfer functions comprise stable poles of the structure for each modal order and the frequencies comprise modal frequencies of each of the stable poles;
allow a user to input user modal parameters selected from the group consisting of a maximum damping ratio, a maximum number of stable poles to be selected from the stabilization diagram, and a minimum separation in frequency between consecutive stable poles;
obtain stable poles having a damping ratio that is less than or equal to the maximum damping ratio from the stabilization diagram;
form a histogram having bins, wherein each bin has a width approximately equal to the minimum separation in frequency between the consecutive stable poles; and
automatically extract the modal parameter of the structure using the histogram.

8. The modal parameter extraction system of claim 7, wherein the structure is an aircraft structure, an automobile structure, a bridge structure, a building structure, an engine structure, and/or a brake disc structure.

9. The modal parameter extraction system of claim 7, wherein the modal parameter of the structure is selected from the group consisting of a natural frequency, a mode shape and a damping ratio.

10. The modal parameter extraction system of claim 7, wherein the modal parameter extraction tool further having instructions to:
filter out bins having no stable poles;
select remaining bins in a decreasing order of a number of stable poles in each of the remaining bins; and
extract the modal parameter of the structure using the selected remaining bins.

11. The modal parameter extraction system of claim 10, wherein the modal parameter extraction tool further having instructions to:
calculate a distance parameter for each of the stable poles in one of the remaining bins;
calculate a first difference for each of the stable poles in the one of the remaining bins in an increasing order of frequency; and
select one of the stable poles having a minimum first difference in the one of the remaining bins.

12. The modal parameter extraction system of claim 11, the modal parameter extraction tool further having instructions to:
repeat the steps of calculating the distance parameter, calculating the first difference and selecting a stable pole in a next bin of the remaining bins.

13. At least one non-transitory computer-readable storage medium for automatic modal parameter extraction in structural dynamics analysis having instructions that, when executed by a computing device, cause the computing device to:
obtain a stabilization diagram of a structure using a frequency domain parameter extraction technique, wherein the stabilization diagram is a graph of measured transfer functions versus frequencies, wherein the measured transfer functions comprise stable poles of the structure for each modal order and the frequencies comprise modal frequencies of each of the stable poles;
allow a user to input user modal parameters selected from the group consisting of a maximum damping ratio, a maximum number of stable poles to select from the stabilization diagram, and a minimum separation in frequency between consecutive stable poles;
obtain stable poles having a damping ratio that is less than or equal to the maximum damping ratio;
form a histogram having bins, wherein bin has a width approximately equal to the minimum separation in frequency between the consecutive stable poles; and
automatically extract the modal parameter of the structure using the histogram.

14. The at least one non-transitory computer-readable storage medium of claim 13, wherein the structure is an aircraft structure, an automobile structure, a bridge structure, a building structure, an engine structure, and/or a brake disc structure.

15. The at least one non-transitory computer-readable storage medium of claim 13, wherein the modal parameter of the structure is selected from the group consisting of a natural frequency, a mode shape and a damping ratio.

16. The at least one non-transitory computer-readable storage medium of claim 13, wherein automatically extracting the modal parameter of the structure using the histogram comprises:
filtering out bins having no stable poles;
selecting remaining bins in a decreasing order of a number of stable poles in each of the remaining bins; and
extracting the modal parameter of the structure using the selected remaining bins.

17. The at least one non-transitory computer-readable storage medium of claim 16, wherein extracting the modal parameter of the structure using the selected remaining bins comprises:
calculating a parameter for each of the stable poles in one of the remaining bins using distance of the stable pole in a hypothetical plane;
calculating a first difference for each of the stable poles in the one of the remaining bins in an increasing order of frequency; and
selecting one of the stable poles having a minimum first difference in the one of the remaining bins.

18. The at least one non-transitory computer-readable storage medium of claim 17, further comprising:
repeating the steps of calculating the parameter, calculating the first difference and selecting a stable pole in a next bin in the remaining bins.
